(19) United States
(12) Patent Application Publication
(10) Pub. No.: US 2004/0021997 A1
(43) Pub. Date: Feb. 5, 2004

(54) Novel ESD protection circuit for I/O circuitry

(75) Inventor: Hsia Liang Choo, Singapore (SG)

Correspondence Address: GEORGE O. SAILE & ASSOCIATES, 28 DAVIS AVENUE, POUGHKEEPSIE, NY, 12603, US

(73) Assignee: Chartered Semiconductor Manufacturing Ltd.

(21) Appl. No.: 10/209,152

(22) Filed: Jul. 30, 2002

(51) Int. Cl. H02H 9/00

(52) U.S. Cl. 361/56

(57) ABSTRACT

According to the present invention, a circuit and a method for protecting the input/output circuitry of an integrated circuit from electrostatic discharge damage is described. In addition, this ESD protection is achieved with as low a snapback voltage as possible to minimize any chance of ESD damage or product reliability. This invention is achieved by a circuit with an electrostatic device ESD protection circuit for input/output, I/O circuitry made up of a p-channel depletion mode metal oxide semiconductor field effect transistor, MOSFET, PA, whose gate is connected to an I/O pad, and an n-channel depletion mode metal oxide semiconductor field effect transistor, MOSFET, NA, whose gate is connected to the I/O pad. The objective of these depletion mode FET devices is to trigger a floating condition for the integrated circuit body or substrate when ESD takes place.

### BACKGROUND OF THE INVENTION

1. Field of the Invention

The present invention generally relates to electrostatic discharge protection circuitry. More particularly, an ESD protection circuit for input/output pads of an integrated circuit is described as utilizing depletion mode devices to trigger a floating condition to protect internal transistors from damage.

2. Description of the Prior Art

FIG. 1 shows a diagram of a prior art electrostatic discharge protection circuit for Input/Output, I/O circuits. An I/O pad 110 is the interface to the outside world. In addition, the pad connects to the ESD protection circuit at 160. A gated p-channel metal oxide semiconductor field effect transistor PMOS FET is shown 120. Its source and gate are connected to the Vdd voltage supply 140. Its drain 160 is connected to the node made up of the I/O pad 110, the drain of a gated NMOS device 130 and one side of a resistor 170. The other side of the resistor 170 is connected to an inverter 180. The output of the inverter 190 becomes the on-chip signal. The source of the gated NMOS device is 150. The source and gate of NMOS 130 are connected to Vss or ground 150.

FIG. 1 which shows a diagram of a prior art electrostatic discharge protection circuit for Input/Output, I/O circuits, shows I/O pad 110 being the interface to the outside world. The body of the integrated circuit is tied to ground 150. This is seen with the gated NMOS 130 having its well connected to ground 150. This type of substrate or well connection gives rise to a high snapback voltage. This high snapback voltage results in a high degree of ESD damage.

U.S. Pat. No. 6,114,731 (London) “Low Capacitance ESD Structure Having Source Inside a Well and the Bottom Portion of the Drain Inside a Substrate” describes a low input capacitance circuit which uses gated transistors and p-channel devices.

U.S. Pat. No. 6,194,764 (Gossner et al.) “Integrated Semiconductor Circuit with Protection Structure for Protecting Against Electrostatic Discharge” describes an ESD protection circuit which uses gated transistors and a vertical transistor.

U.S. Pat. No. 5,615,073 (Fried et al.) “Electrostatic Discharge Protection Apparatus” discloses an ESD protection apparatus which includes a protection structure and a set of layout design rules.

U.S. Pat. No. 5,955,763 (Lin) “Low Noise, High Current-Drive MOSFET Structure for Uniform Serpentine-Shaped Poly-Gate Turn-on During and ESD Event” discloses an ESD protection structure which utilizes a multi-gate-finger MOSFET structure.

U.S. Pat. No. 6,097,071 (Krakauer) “ESD Protection Clamp for Mixed Voltage I/O Stages Using NMOS Transistors” discloses an ESD protection device for protecting a mixed voltage integrated circuit against damage. The circuit includes at least one pair of NMOS transistors connected in cascode configuration.

### SUMMARY OF THE INVENTION

It is therefore an object of the present invention to provide a circuit and a method for protecting the input/output circuitry of an integrated circuit from electrostatic discharge damage. It is further an object of this invention to achieve this ESD protection with as low a snapback voltage as possible to minimize any chance of ESD damage or product reliability. As can be followed in FIG. 2, this invention is achieved by a circuit with an electrostatic device ESD protection circuit for input/output, I/O circuitry made up of a p-channel depletion mode metal oxide semiconductor field effect transistor, MOSFET, P2, 275 whose gate is connected to an I/O pad 210, and an n-channel depletion mode metal oxide semiconductor field effect transistor, MOSFET, N2, 285 whose gate is connected to the I/O pad 210. The ESD protection circuit for I/O circuitry is also made up of a p-channel MOSFET, P1 220 whose body is tied to the source of the n-channel depletion mode MOSFET, N2, 285 and an n-channel MOSFET, N1 230 whose body is tied to the drain of the p-channel depletion mode MOSFET, P2, 275. The ESD protection circuit for I/O circuitry contains a p-channel depletion mode MOSFET, P2 has its gate connected to an I/O pad 210, the MOSFET PA has its drain connected to Vss 295 or ground, and the MOSFET P2, 275 has its source connected to the body of an n-channel MOSFET device N1 230. The ESD protection circuit for I/O circuitry also has an n-channel depletion mode MOSFET, N2, 285 which has its gate connected to an I/O pad 210, the MOSFET N2, 285 has its drain connected to Vdd 290, and the MOSFET N2, 285 has its source connected to the body of a p-channel MOSFET device P1, 220.

The purpose of the n-channel depletion device, N2, 285 and the p-channel depletion device, P2, 275 is to trigger a floating condition for the body or substrate of the I/O circuits when ESD events take place. This action will minimize the snapback voltage and also reduce the probability of ESD damage.

The above and other objects, features and advantages of the present invention will be better understood from the following detailed description taken in conjunction with the accompanying drawings.

### BRIEF DESCRIPTION OF THE DRAWINGS

FIG. 1 shows a circuit diagram of a prior art ESD protection circuit.

FIG. 2 is a diagram of an ESD protection circuit embodiment of this invention.

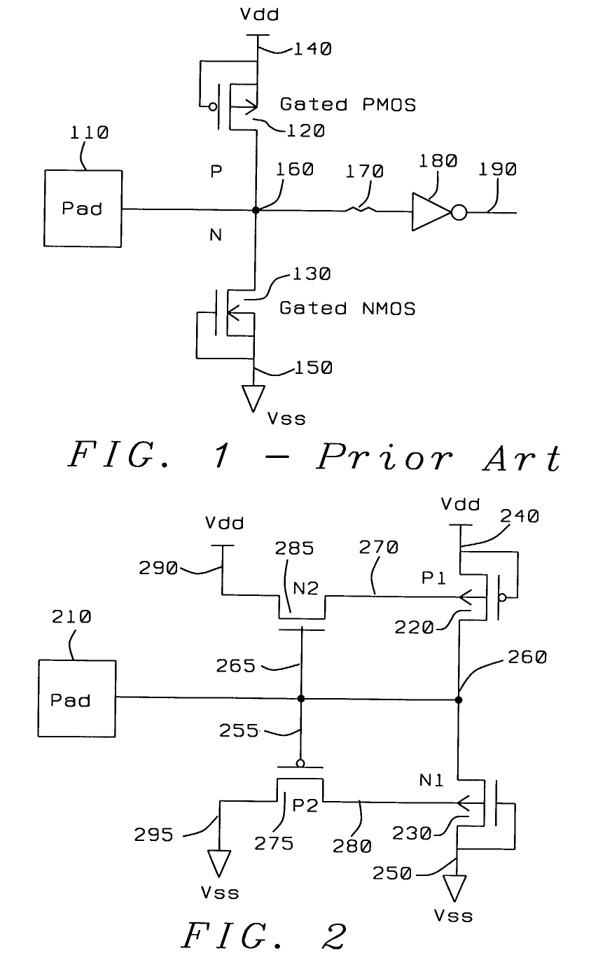

### DESCRIPTION OF THE PREFERRED EMBODIMENT

FIG. 2 shows a circuit diagram of the main embodiment of this invention. The I/O pad 210 is the interface to the outside world. The gates of a depletion mode gated NMOS FET device 285 and a depletion mode gated PMOS FET device 275 are connected to the I/O pad 210. The drain 290 of the gated NMOS device 285 is connected to the Vdd supply voltage. The source 270 of the gated NMOS device 285 is connected to the body or well of an enhancement mode PMOS FET device 220.

The drain 295 of the gated PMOS device 275 is connected to Vss or ground. The source 280 of the gated PMOS device 275 is connected to the body or well of an enhancement mode NMOS device 230.

The drain and gate of the enhancement mode PMOS device 220 are connected to the Vdd supply voltage 240. The source 260 of the enhancement mode PMOS device 220 is connected to the node which is attached to the I/O pad, to the gate 265 of the depletion mode NMOS device and to the gate 255 of the depletion mode PMOS device.

The drain and gate of the enhancement mode NMOS device 230 is connected to Vss or ground 250. The source of enhancement mode NMOS device 230 is also connected to the node 260 which is attached to the I/O pad and to the gate of the depletion mode gated NMOS device 285 and to the gate of the depletion mode gated PMOS device 275.

In this invention, the p-channel depletion mode MOSFET device P2, 275 is used for the gated NMOS portion to trigger a floating condition for the integrated circuit body when ESD takes place. Similarly, an n-channel depletion mode device, N2, 285 is used for the gate PMOS portion to trigger a floating condition for the integrated circuit body when ESD takes place.

As is shown in FIG. 2, P2, 275 is a p-channel depletion mode MOS device made of field oxide, e.g. LOCOS or shallow trench (STI) isolation oxide. The oxide is thick so that under normal operating conditions, device P2, 275 is conducting to maintain device N1's 230 body grounded. When an ESD pulse strikes against Vss 295, (assuming the pulse is positive), device P2, 275 is cut off and device N1's 230 body is then floating. This will make device N1 230 snapback at a much lower voltage than for the case when N1's 230 body is tied to Vss 295. This allows the ESD current to bypass the path to N1's 230 body. This eliminates any ESD damage to input/output devices such as N1 230.

Similarly as is shown in FIG. 2, N2, 285 is an n-channel depletion mode MOS device made of field oxide, e.g. LOCOS or shallow trench (STI) isolation oxide. The oxide is thick so that under normal operating conditions, device N2, 285 is conducting to maintain device P1's 220 body at the Vdd level. When an ESD pulse strikes against Vdd 290, (assuming the pulse is negative), device N2, 285 is cut off and device P1's 220 body is then floating. This will make device P1 220 snapback at a much lower voltage than for the case when P1's 220 body is tied to Vdd 290. This allows the ESD current to bypass the path to P1's 220 body. This eliminates any ESD damage to input/output devices such as P1 220.

Compared with the prior art electrostatic discharge circuits, the circuit and method of this invention provide for a lower snapback voltage. This results is a much lower probability of ESD damage. It also provides for more reliable and longer lasting circuitry.

While the invention has been described in terms of the preferred embodiments, those skilled in the art will recognize that various changes in form and details may be made without departing from the spirit and scope of the invention.

What is claimed is:

1. An electrostatic device ESD protection circuit for input/output, I/O circuitry comprising:
a p-channel depletion mode metal oxide semiconductor field effect transistor, MOSFET, PA, whose gate is connected to an I/O pad, and
an n-channel depletion mode metal oxide semiconductor field effect transistor, MOSFET, NA, whose gate is connected to said I/O pad.

2. The ESD protection circuit for I/O circuitry of claim 1 further comprising:
a p-channel MOSFET, PB whose body is tied to the source of said n-channel depletion mode MOSFET, NA, and
an n-channel MOSFET, NB whose body is tied to the drain of said p-channel depletion mode MOSFET, PA.

3. The ESD protection circuit for I/O circuitry of claim 1 wherein said p-channel depletion mode MOSFET, PA has its gate connected to an I/O pad, said MOSFET PA has its drain connected to Vss or ground, and said MOSFET PA has its source connected to the body of an n-channel MOSFET device NB.

4. The ESD protection circuit for I/O circuitry of claim 1 wherein said n-channel depletion mode MOSFET, NA has its gate connected to an I/O pad, said MOSFET NA has its drain connected to Vdd, and said MOSFET NA has its source connected to the body of a p-channel MOSFET device PB.

5. The ESD protection circuit for I/O circuitry of claim 2 wherein said p-channel MOSFET, PB has its gate connected to Vdd, said MOSFET PB has its source connected to Vdd, and said MOSFET PB has its drain connected to said I/O pad, to said gates of MOSFETs PA and NA, and to the drain of said n-channel MOSFET, NB.

6. The ESD protection circuit for I/O circuitry of claim 2 wherein said n-channel MOSFET, NB has its gate connected to Vss or ground, said MOSFET NB has its source connected to Vss or ground, and said MOSFET NB has its drain connected to said I/O pad, to said gates of MOSFETs PA and NA, and to the drain of said p-channel MOSFET, PB.

7. The ESD protection circuit for I/O circuitry of claim 1 wherein said p-channel MOSFET PA is a depletion mode type of device which is produced with a special ion implant such as boron.

8. The ESD protection circuit for I/O circuitry of claim 1 wherein said n-channel MOSFET NA is a depletion mode type of device which is produced with a special ion implant such as arsenic or phosphorus.

9. The ESD protection circuit for I/O circuitry of claim 1 wherein said p-channel MOSFET PB is an enhancement type of device.

10. The ESD protection circuit for I/O circuitry of claim 1 wherein said n-channel MOSFET NB is an enhancement type of device.

11. The ESD protection circuit for I/O circuitry of claim 1 wherein under normal operating conditions said p-channel MOSFET PB is ON and conducting to maintain said n-channel MOSFET NB's body grounded or equal to Vss.

12. The ESD protection circuit for I/O circuitry of claim 1 wherein under normal operating conditions said n-channel MOSFET NB is ON and conducting to maintain said p-channel MOSFET PB's body grounded or equal to Vdd.

13. The ESD protection circuit for I/O circuitry of claim 1 wherein under high voltage operating conditions whereby a positive ESD pulse strikes Vss, said p-channel MOSFET PB is CUT OFF, allowing the body of said n-channel MOSFET NB's body to float.

14. The ESD protection circuit for I/O circuitry of claim 13 wherein said positive ESD pulse on Vss causes the body of said n-channel MOSFET NB to float, will make the snapback breakdown of said device NB to occur at a much lower voltage than the case when device NB's body is tied to Vss or ground.

15. The ESD protection circuit for I/O circuitry of claim 14 wherein the snapback breakdown voltage of device NB occurs at a lower voltage, resulting in the bypassing of the ESD current without the result of any damage.

16. The ESD protection circuit for I/O circuitry of claim 1 wherein under high voltage operating conditions whereby a negative ESD pulse strikes Vdd, said n-channel MOSFET NB is CUT OFF, allowing the body of said p-channel MOSFET PB's body to float.

17. The ESD protection circuit for I/O circuitry of claim 16 wherein said negative ESD pulse on Vdd causes the body of said p-channel MOSFET PB to float, will make the snapback breakdown of said device PB to occur at a much lower voltage than the case when device PB's body is tied to Vdd.

18. The ESD protection circuit for I/O circuitry of claim 17 wherein the snapback breakdown voltage of device PB occurs at a lower voltage, resulting in the bypassing of the ESD current without the result of any damage.

19. A method of protecting I/O circuits using an electrostatic device ESD protection circuit comprising the steps of:
using a p-channel depletion mode metal oxide semiconductor field effect transistor, MOSFET, PA, whose gate is connected to an I/O pad, and
using an n-channel depletion mode metal oxide semiconductor field effect transistor, MOSFET, NA, whose gate is connected to said I/O pad.

20. The method of protecting I/O circuits using an electrostatic device ESD protection circuit of claim 19 further comprising the steps of:
using a p-channel MOSFET, PB whose body is tied to the source of said n-channel depletion mode MOSFET, NA, and
using an n-channel MOSFET, NB whose body is tied to the drain of said p-channel depletion mode MOSFET, PA.

21. The method of protecting I/O circuits using an electrostatic device ESD protection circuit of claim 19 wherein under normal operating conditions said p-channel MOSFET PB is ON and conducting to maintain said n-channel MOSFET NB's body grounded or equal to Vss.

22. The method of protecting I/O circuits using an electrostatic device ESD protection circuit of claim 19 wherein under normal operating conditions said n-channel MOSFET NB is ON and conducting to maintain said p-channel MOSFET PB's body grounded or equal to Vdd.

23. The method of protecting I/O circuits using an electrostatic device ESD protection circuit of claim 19 wherein under high voltage operating conditions whereby a positive ESD pulse strikes Vss, said p-channel MOSFET PB is CUT OFF, allowing the body of said n-channel MOSFET NB's body to float.

24. The method of protecting I/O circuits using an electrostatic device ESD protection circuit of claim 19 wherein said positive ESD pulse on Vss causes the body of said n-channel MOSFET NB to float, will make the snapback breakdown of said device NB to occur at a much lower voltage than the case when device NB's body is tied to Vss or ground.

25. The method of protecting I/O circuits using an electrostatic device ESD protection circuit of claim 19 wherein the snapback breakdown voltage of device NB occurs at a lower voltage, resulting in the bypassing of the ESD current without the result of any damage.

26. The method of protecting I/O circuits using an electrostatic device ESD protection circuit of claim 19 wherein under high voltage operating conditions whereby a negative ESD pulse strikes Vdd, said n-channel MOSFET NB is CUT OFF, allowing the body of said p-channel MOSFET PB's body to float.

27. The method of protecting I/O circuits using an electrostatic device ESD protection circuit of claim 19 wherein said negative ESD pulse on Vdd causes the body of said p-channel MOSFET PB to float, will make the snapback breakdown of said device PB to occur at a much lower voltage than the case when device PB's body is tied to Vdd.

28. The method of protecting I/O circuits using an electrostatic device ESD protection circuit of claim 19 wherein the snapback breakdown voltage of device PB occurs at a lower voltage, resulting in the bypassing of the ESD current without the result of any damage.
